(19) United States
(12) Patent Application Publication
(10) Pub. No.: US 2002/0007561 A1
(43) Pub. Date: Jan. 24, 2002

(54) LIGHT SWITCH/WALL PLUG TRANSFER KIT SYSTEM

(76) Inventor: JOHN T. MALIZIA, NEW CASTLA, PA (US)

Correspondence Address: MICHAEL J COLITZ JR, 217 HARBOR VIEW LANE, LARGO, FL, 33770

(21) Appl. No.: 09/419,500

(22) Filed: Oct. 18, 1999

(51) Int. Cl. G01B 3/10

(52) U.S. Cl. 33/528; 33/764; 33/DIG. 1

(57) ABSTRACT

A light switch/wall plug transfer system includes a rectilinear container having a front plate and a similarly configured parallel rear plate. The container also has a top plate and a similarly configured parallel bottom plate. The container also has an exterior side plate and a similarly configured parallel interior side plate. A first rectangular upper opening is formed across the interior side plate parallel with and adjacent to the top plate. A second rectangular lower opening is formed across the bottom plate parallel with and adjacent to the exterior side plate. A first upper tape measure is position in the upper opening. A second lower tape measure is position in the bottom opening.

### BACKGROUND OF THE INVENTION

1. Field of the Invention

The present invention relates to a light switch/wall plug transfer system and more particularly pertains to properly positioning a light switch/wall plug assembly from one position prior to drywalling and/or paneling to a subsequent drywall and/or panel.

2. Description of the Prior Art

The use of measuring devices of known designs and configurations is known in the prior art. More specifically, measuring devices of known designs and configurations heretofore devised and utilized for the purpose of positioning components at proper locations through known methods and apparatuses are known to consist basically of familiar, expected, and obvious structural configurations, notwithstanding the myriad of designs encompassed by the crowded prior art which has been developed for the fulfillment of countless objectives and requirements.

By way of example, U.S. Pat. No. 2,240,753 to Bouchard, et al discloses a measuring device. U.S. Pat. No. 3,885,324 to Banas discloses a two-way tape and centering device. U.S. Pat. No. 4,056,446 to Mitchell discloses a tape measure having two tapes. Lastly, U.S. Pat. No. 3,760,766 to Wopschall discloses an indicating device.

While these devices fulfill their respective, particular objectives and requirements, the aforementioned patents do not describe a light switch/wall plug transfer system that allows properly positioning a light switch/wall plug assembly from one position prior to drywalling and/or paneling to a subsequent drywall and/or panel.

In this respect, the light switch/wall plug transfer system according to the present invention substantially departs from the conventional concepts and designs of the prior art, and in doing so provides an apparatus primarily developed for the purpose of properly positioning a light switch/wall plug assembly from one position prior to drywalling and/or paneling to a subsequent drywall and/or panel.

Therefore, it can be appreciated that there exists a continuing need for a new and improved light switch/wall plug transfer system which can be used for properly positioning a light switch/wall plug assembly from one position prior to drywalling and/or paneling to a subsequent drywall and/or panel. In this regard, the present invention substantially fulfills this need.

### SUMMARY OF THE INVENTION

In view of the foregoing disadvantages inherent in the known types of measuring devices of known designs and configurations now present in the prior art, the present invention provides an improved light switch/wall plug transfer system. As such, the general purpose of the present invention, which will be described subsequently in greater detail, is to provide a new and improved light switch/wall plug transfer system and method which has all the advantages of the prior art and none of the disadvantages.

To attain this, the present invention essentially comprises a new and improved light switch/wall plug transfer kit system to properly position a light switch/wall plug assembly from one position to another position. A rectilinear container is first provided. The container has a rectangular imperforate front plate. The front plate is about 2¼ inches by about 3½ inches. A similarly configured parallel rear plate is also provided. The front plate and rear plate each have parallel side edges and parallel end edges. The container also has a rectangular imperforate top plate. The top plate is about 2¼ inches by about 2½ inches. A similarly configured parallel bottom plate is also provided. The top plate and bottom plate each have parallel side edges and parallel end edges. The container also has a rectangular imperforate exterior side plate. The side plate is about 3½ inches by about 2½ inches. A similarly configured parallel interior side plate is also provided. The exterior side plate and interior side plate each have parallel side edges and parallel end edges. A first rectangular upper opening is formed across the interior side plate. The upper opening is parallel with and adjacent to the top plate. A second lower rectangular lower opening is formed across the bottom plate. The lower opening is parallel with and adjacent to the exterior side plate. A first upper tape measure is positioned in the upper opening. A flexible tape is provided and is adapted to be withdrawn from the upper tape measure parallel with and essentially co-planarly within the rear face. An L-shaped tab is provided at the end of the tape and extending away from the front plate. A locking mechanism is provided. The locking mechanism is exposed through the opening for releasably securing the tape in a predetermined position during operation and use.

A second lower tape measure is positioned in the bottom opening. A flexible tape is provided. The flexible tape is adapted to be withdrawn from the lower tape measure parallel with and essentially co-planarly with the lower face and essentially. An L-shaped tab is provided at the end of the tape and extends away from the front plate. A locking mechanism is provided. The locking mechanism is exposed through the opening for releasably securing the tape in the predetermined position during operation and use.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved light switch/wall plug transfer system which has all of the advantages of the prior art measuring devices of known designs and configurations and none of the disadvantages.

It is another object of the present invention to provide a new and improved light switch/wall plug transfer system which may be easily and efficiently manufactured and marketed.

It is further object of the present invention to provide a new and improved light switch/wall plug transfer system which is of durable and reliable constructions.

An even further object of the present invention is to provide a new and improved light switch/wall plug transfer system which is susceptible of a low cost of manufacture with regard to both materials and labor, and which accordingly is then susceptible of low prices of sale to the consuming public, thereby making such light switch/wall plug transfer system economically available to the buying public.

Even still another object of the present invention is to provide a light switch/wall plug transfer system for properly positioning a light switch/wall plug assembly from one position prior to drywalling and/or paneling to a subsequent drywall and/or panel.

Lastly, it is an object of the present invention to provide a new and improved light switch/wall plug transfer system. A rectilinear container has a front plate and a similarly configured parallel rear plate. The container also has a top plate and a similarly configured parallel bottom plate. The container also has an exterior side plate and a similarly configured parallel interior side plate. A first rectangular upper opening is formed across the interior side plate parallel with and adjacent to the top plate. A second rectangular lower opening is formed across the bottom plate parallel with and adjacent to the exterior side plate. A first upper tape measure is position in the upper opening. A second lower tape measure is position in the bottom opening.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective illustration of the new and improved light switch/wall plug transfer system when measuring prior to drywalling and/or paneling constructed in accordance with the principles of the present invention.

FIG. 2 is a perspective view similar to FIG. 1 but illustrating the subsequent measuring on drywall and/or paneling.

FIG. 3 is a front elevational view of the system as shown in FIGS. 1 and 2.

FIG. 4 is an elevational view of the interior side panel taken along line 4-4 of FIG. 3.

FIG. 5 is a bottom view of the bottom panel taken along line 5-5 of FIG. 4.

FIG. 6 is a cross sectional view taken along line 6-6 of FIG. 5.

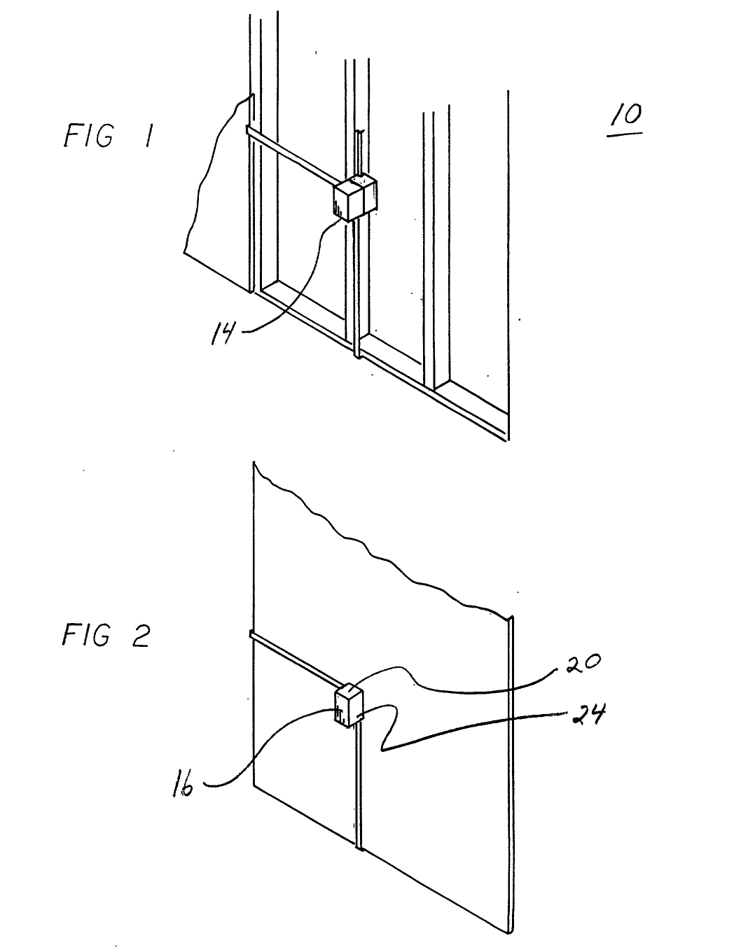

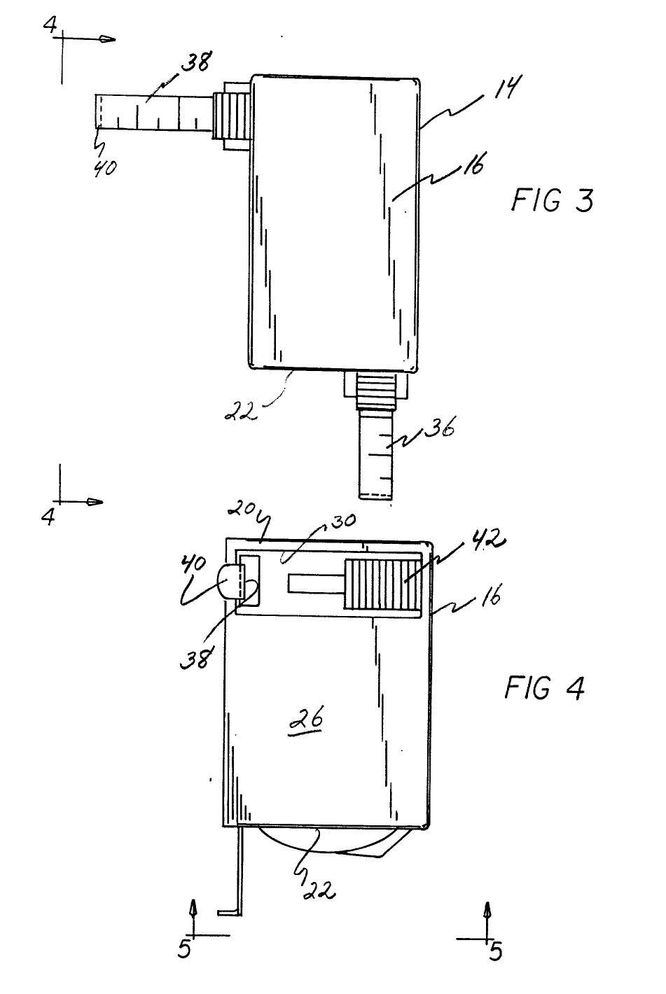

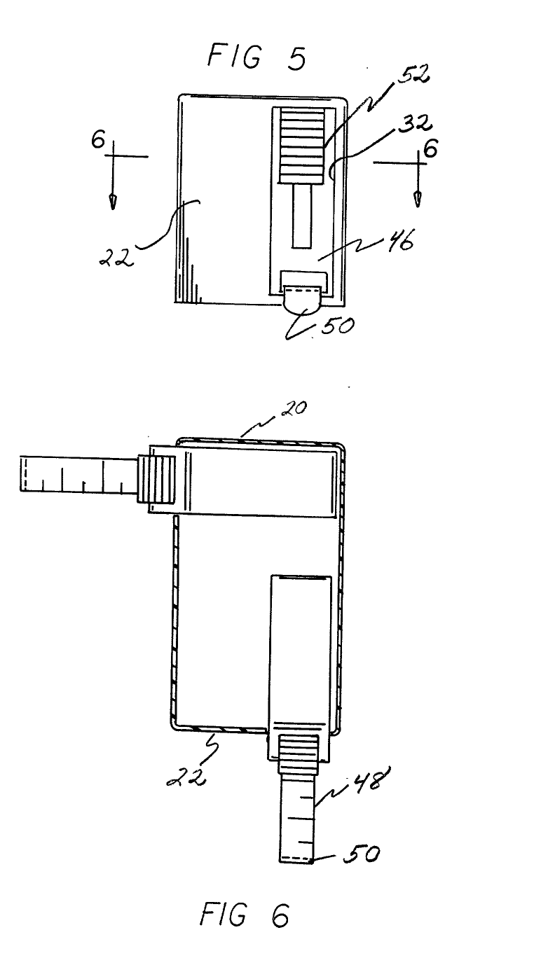

The same reference numerals refer to the same parts throughout the various Figures.

### DESCRIPTION OF THE PREFERRED EMBODIMENT

With reference now to the drawings, and in particular to FIG. 1 thereof, the preferred embodiment of the new and improved light switch/wall plug transfer system embodying the principles and concepts of the present invention and generally designated by the reference numeral 10 will be described.

The present invention, the light switch/wall plug transfer system 10 is comprised of a plurality of components. Such components in their broadest context include a rectilinear container having a first rectangular upper opening and a second rectangular opening, a first upper tape measure, and a second lower tape measure. Such components are individually configured and correlated with respect to each other so as to attain the desired objective.

A rectilinear container 14 has a rectangular imperforate front plate 16. The front plate is about 2¼ inches by about 3½ inches. A similarly configured parallel rear plate is also provided. The front plate and rear plate each have parallel side edges and parallel end edges. The container also has a rectangular imperforate top plate 20. The top plate is about 2¼ inches by about 2½ inches. A similarly configured parallel bottom plate 22 is also provided. The top plate and bottom plate each have parallel side edges and parallel end edges. The container also has a rectangular imperforate exterior side plate 24. The side plate is about 3½ inches by about 2½ inches. A similarly configured parallel interior side plate 26 is also provided. The exterior side plate and interior side plate each have parallel side edges and parallel end edges.

A first rectangular upper opening 30 is formed across the interior side plate. The upper opening is parallel with and adjacent to the top plate.

A second lower rectangular lower opening 32 is formed across the bottom plate. The lower opening is parallel with and adjacent to the exterior side plate.

A first upper tape measure 36 is positioned in the upper opening. A flexible tape 38 is provided and is adapted to be withdrawn from the upper tape measure parallel with and essentially co-planarly within the rear face. An L-shaped tab 40 is provided at the end of the tape and extending away from the front plate. A locking mechanism 42 is provided. The locking mechanism is exposed through the opening for releasably securing the tape in a predetermined position during operation and use.

A second lower tape measure 46 is positioned in the bottom opening. A flexible tape 48 is provided. The flexible tape is adapted to be withdrawn from the lower tape measure parallel with and essentially co-planarly with the lower face and essentially. An L-shaped tab 50 is provided at the end of the tape and extends away from the front plate. A locking mechanism 52 is provided. The locking mechanism is exposed through the opening for releasably securing the tape in the predetermined position during operation and use.

Paneling and drywall are made in 4 ft.×8 ft. sheets. The light switch/wall plug transfer kit was designed to make transferring the position of light switches and wall plugs to paneling and drywall, when paneling or putting up drywall. It makes the process simpler, faster and more precise than just trying to use a tape measure to measure and transfer to either paneling or drywall.

The process is very simple to use and understand. 1.) The transfer kit is placed directly over the light switch or wall plug to be transferred. 2.) The bottom tape is moved to the bottom where the drywall or paneling will sit and the tape is locked in place. 3.) The side tape is placed where the next drywall or panel will start and the side tape is locked in place. The user now has the exact spot of the light switch or wall plug to transfer over to the drywall or paneling. The transfer kit with the tapes locked in place is then placed on the drywall or paneling. The side tape is positioned on the side of the drywall or panel, and the bottom tape is positioned on the bottom of the drywall or panel. The user then traces around the transfer box, giving the exact location to cut out for the light switch or wall plug.

In the event that the light switch or wall plug is a double or triple light switch or wall plug, the process is still the same with a few changes. The same process is followed. The tapes are set, making sure that the transfer kit is positioned either on the far upper right or far upper left of the double switch or plug. Transfer and trace the single switch or plug onto the drywall or paneling. Now, using either the double light switch or the double wall plug which are provided with the kit, place it on the far upper right or far upper left corner, depending upon where you placed the transfer kit on the double light switch or wall plug, of the single light switch or wall plug that has been traced onto the drywall or paneling. Finally, the rest of the double plug/switch is traced onto the drywall or paneling and the cut out is made for a perfect match.

Paneling or drywall adds beauty or insulation or both to any room. However, installations can be difficult and time consuming. The system of the present invention simplifies and speeds this job, making it easier for both contractors and home do-it-yourselfers.

The system of the present invention eliminates making costly mistakes, thereby ruining pieces of drywall or paneling. The system of the present invention is much easier to work with than are prior devices. By working with the system of the present invention installations are accomplished more quickly with a resulting increase in profit to contractors. The system of the present invention is so easy to use, that even home do-it-yourselfers will be able to use it and make exact cut.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A new and improved light switch/wall plug transfer kit system to properly position a light switch/wall plug assembly from one position to another position comprising, in combination:
a rectilinear container having a rectangular imperforate front plate 16 about 2¼ inches by about 3½ inches and a similarly configured parallel rear plate, each with parallel side edges and parallel end edges, the container also having a rectangular imperforate top plate about 2¼ inches by about 2½ inches and a similarly configured parallel bottom plate, each with parallel side edges and parallel end edges, and the container also having a rectangular imperforate exterior side plate about 3½ inches by about 2½ inches and a similarly configured parallel interior side plate, each with parallel side edges and parallel end edges;
a first rectangular upper opening formed across the interior side plate parallel with the top plate and adjacent thereto;
a second lower rectangular lower opening formed across the bottom plate parallel with the exterior side plate and adjacent thereto;
a first upper tape measure positioned in the upper opening with a flexible tape adapted to be withdrawn therefrom parallel with the rear face and essentially co-planarly therewith and with an L-shaped tab at the end of the tape and extending away from the front plate and with a locking mechanism being exposed through the opening for releasably securing the tape in a predetermined position during operation and use; and
a second lower tape measure positioned in the bottom opening with a flexible tape adapted to be withdrawn therefrom parallel with the lower face and essentially co-planarly therewith and an L-shaped tab at the end of the tape and extending away from the front plate and with a locking mechanism being exposed through the opening for releasably securing the tape in the predetermined position during operation and use.

2. A light switch/wall plug transfer kit comprising:
a rectilinear container having a front plate and a similarly configured parallel rear plate, the container also having a top plate and a similarly configured parallel bottom plate, the container also having an exterior side plate and a similarly configured parallel interior side plate;
a first rectangular upper opening formed across the interior side plate parallel with the top plate and adjacent thereto;
a second rectangular lower opening formed across the bottom plate parallel with the exterior side plate and adjacent thereto;
a first upper tape measure position in the upper opening; and
a second lower tape measure position in the bottom opening.

3. The system as set forth in claim 2 wherein each tape measure has a flexible tape adapted to be withdrawn therefrom.

4. The system as set forth in claim 3 wherein each tape measure has an L-shaped tab at the end of the tape extending away from the front plate.

5. The system as set forth in claim 2 wherein each tape measure has a locking mechanism.
